(19) United States
(12) Patent Application Publication
(10) Pub. No.: US 2011/0131520 A1
(43) Pub. Date: Jun. 2, 2011

(54) System and method for transferring media content from a mobile device to a home network

(76) Inventors: Osama Al-Shaykh, San Diego, CA (US); Dann Wilkens, Cardiff, CA (US); Benjamin Indyk, San Diego, CA (US)

(21) Appl. No.: 12/927,925

(22) Filed: Nov. 29, 2010

Related U.S. Application Data
(60) Provisional application No. 61/283,423, filed on Dec. 2, 2009.

(51) Int. Cl. G06F 3/048

(52) U.S. Cl. 715/772; 715/771

(57) ABSTRACT

A system and a method transfer media content from a mobile device to a home network. A media application on the mobile device may be enabled to share media content with rendering devices in the home network. A user may enable and disable transfer of the media content from the media application to a target rendering device. Further, the media application may indicate visually the target rendering device and whether the media content is currently being transferred. Still further, the user may select a new target rendering device. Moreover, the media application may indicate network errors or other problems which may prevent the rendering of the media content and may enable the user to correct the network errors or the other problems.

This application claims the benefit of U.S. Provisional Application Ser. No. 61/283,423, filed Dec. 2, 2009.

### BACKGROUND OF THE INVENTION

The present invention generally relates to a system and a method for transferring media content from a mobile device to a home network. More specifically, the present invention relates to a system and a method which enable a media application on the mobile device to share media content with rendering devices in the home network.

Known mobile devices may support media functions, such as creation, discovery, organization, management, and/or playback of media content which may include video, audio and/or image content. Examples of mobile devices which support media functions are portable music players, portable video players, portable gaming devices, PDAs and mobile telephones. Some of these devices may be classified as general computing devices which have operating systems and which allow the user to install and run applications. A mobile device may support media functions using built-in functions of the mobile device, built-in applications of the mobile device, and/or other applications which may include applications installed by the user.

Media home networking is gaining popularity. An increasing number of affordable rendering devices, such as televisions, stereos, gaming consoles, and digital photo frames, may support home networking standards, such as the Universal Plug and Play (UPnP) Audio and Video (AV) standard and the Digital Living Network Alliance (DLNA) specifications. Home networking standards allow the rendering devices to connect to a home network using a suitable connection, such as IEEE 802.11, wired Ethernet cables, or FireWire (trademark of Apple Computer, Inc.). Rendering devices in the home network may discover, may access and/or may play media content accessible using the home network. For example, accessible media content may reside on a media server device, such as a UPnP AV MediaServer accessible using the home network. A network-capable rendering device may present a user interface by which a user may discover, may select, may render and/or may control the accessible media content using the rendering device. Alternatively, an external control point may be used to discover and select the media content for rendering on an available rendering device. The external control point may reside on a PC, a laptop computer, or on a mobile device, such as a PDA or a mobile telephone. Alternatively, the external control point may be a standalone remote control device capable of communicating with media servers and rendering devices in the home network. The external control point may communicate with media server devices and rendering devices in the home network using home networking standards, such as the UPnP AV standard, the DLNA specifications, and other standard media networking protocols.

A mobile device with media functionality may connect to a home network so that the media content, the applications, and the functions available on the mobile device may be used with the rendering devices available in the home network. For example, a user of a mobile phone may create photographs or videos using the camera of the mobile phone. Such user-generated media content may be transferred and/or may be streamed from the mobile phone to the home network for rendering on a network-capable television which may be available in the home network. Therefore, the user may experience the media content using a video screen which is larger and has a higher quality of rendering relative to the screen of the mobile phone. As another example, a user of a mobile device may have access to music content which may be played back using the mobile device. Such music content may be streamed from the mobile device to the home network for rendering on a network-capable stereo in the home network. Therefore, the user may render the music content on a high quality stereo in the home instead of being limited to playback using the mobile device.

The media content provided by a mobile device may include local media content stored on the mobile device as noted in the two preceding examples. The media content provided by the mobile device may also include media content accessible to the mobile device which is not locally stored on the mobile device. For example, the media content may be streamed from the internet using a media content service accessible to the mobile device. The media content accessible to the mobile device and not locally stored on the mobile device may be accessed using a service-specific application on the mobile device or a more general application, such as a mobile device web browser.

Three well-known approaches share media content from a mobile device to a home network. In the first approach, which may be referred to as the “mobile-device-as-server” approach, the mobile device acts as a media server which makes media content available to other devices using the home network. For example, the mobile device may present itself as a standard UPnP AV MediaServer. Then, control points and rendering devices in the home network may discover the media server and may use the media server to access the local media content stored on the mobile device. Various mobile phones support the “mobile-device-as-server” approach, such as, for example, the Nokia N95 (trademark of Nokia Corporation), the Samsung 1910 OMNIA (trademark of Samsung Electronics Co., Ltd.), and the Sony Ericsson G705 (trademark of Sony Ericsson Mobile Communications AB).

The “mobile-device-as-server” approach allows the mobile device to share media content stored on the mobile device with other devices in the home network. However, the “mobile-device-as-server” approach does not allow the user to control the rendering using the media functions, the applications or the user interface available on the mobile device. The mobile device merely acts as a passive media server, and the user is limited to the user interfaces available on the external control points and the rendering devices in the home network. Such user interfaces are necessarily generic, suitable for browsing and using the content available on any generic media server in the home network. Thus, organization, management, manipulation, and other special features which may be provided by the media functions and the applications of the mobile device are not available and cannot be used in the “mobile-device-as-server” approach.

In the second approach, which may be referred to as the “sharing application” approach, the mobile device may present a special sharing application which allows the media content available on the mobile device to be directed to rendering devices in the home network under the control of the special sharing application. For example, the Samsung i910 OMNIA phone provides a built-in “Connected Home Application” which allows the user to browse and select media content available on the phone, discover and select an appropriate rendering device in the home network, and render the selected content on the selected rendering device. The “Connected Home application” also presents controls by which the user of the mobile device may control the rendering of the selected content on the selected rendering device using the mobile device.

A disadvantage of the “sharing application” approach is that the approach artificially separates the media experience on the mobile device into two areas. The user has various media functions and applications by which media may be created, organized, manipulated, and rendered on the mobile device. However, these functions and applications are unaware of and cannot use rendering devices and other devices in the home network. The user has the separate sharing application which allows the media content stored on the mobile device to be rendered by the external rendering devices. However, the sharing application cannot use the creation, manipulation, organization, or other features of the various other media functions and applications which are available on the mobile device. Further, the user may invest time and effort to learn and become familiar with one or more of the media functions and applications on the mobile device. Then, the user must invest additional time and effort to learn and become familiar with the different user interface of the separate sharing application. Such artificial separation of the media experience is not ideal for the user.

In the third approach, which may be referred to as the “media application extension” approach, the various media functions and applications available on a mobile device may be individually extended with home network sharing capabilities. This approach is followed to some extent by Nokia N-Series phones such as the Nokia N95. The built-in applications, such as “Photos” or “Gallery” in such phones, expose a “Show Via Home Network” function in the Options menu of the application. This function sends the media content viewed or rendered in the application to a rendering device in the home network. The “media application extension” approach is an improvement over the “mobile-device-as-server” and the “sharing application” approach because the user interface of the familiar built-in media applications may be used to access and select the media content if the “Show Via Home Network” function is used. Moreover, the user interface of the familiar built-in media applications may be used to control the rendering of the media content on rendering devices in the home network if the “Show Via Home Network” function is used.

The implementation of the “media application extension” approach on current Nokia N-Series phones has disadvantages. A first disadvantage is that the “Show Via Home Network” function is hidden in the Options menu. Therefore, while using the built-in media applications on a Nokia N-Series phone, the user has no indication that the home network sharing function is available and no visible indication of the status of the home network or the available rendering devices. The user must open the Options menu to discover the “Show Via Home Network” function, and the user must remember where the “Show Via Home Network” function may be found if the Options menu is closed.

A second disadvantage is that the status of the home network and the availability of rendering devices is not displayed and is not accessible until the user invokes the “Show Via Home Network” function. After invoking the “Show Via Home Network” function, the user must wait a delay time while the phone accesses the home network and discovers the available rendering devices for display in a rendering device selection list. The delay time may be significant; for example, the Nokia N95 phone may exhibit a delay time of approximately eight seconds. After waiting the delay time, the user may select an available rendering device from the rendering device selection list. After the user selects the rendering device, the media content which the user views and/or renders in the application is transferred for display on the selected rendering device. Further, the user may use the familiar controls and user interface of the application to select, organize, control and render the media . . . . The selected, rendering device continues to render the media content including new media content which may be selected by the user within the application. However, the application and the mobile device do not display a visible indication of the external rendering or the rendering status. Further, the application and the mobile device do not display a visible control to deactivate the external rendering function, and the control to deactivate the external rendering function is hidden in the Options menu of the application.

### SUMMARY OF THE INVENTION

The present invention generally relates to a system and a method for transferring media content from a mobile device to a home network. More specifically, the present invention relates to a system and a method which enables a media application on the mobile device to share media content with rendering devices in the home network. The system and the method may provide a combination of controls and indications which may enable a user to use the media content in the home network.

To this end, in an embodiment of the present invention, a method for transferring media content from a mobile device to a home network is provided. The mobile device has a user interface, and the home network has rendering devices. The method has the steps of displaying a media transfer control, a media transfer indication and a renderer selection control/indication concurrently in the user interface of the mobile device during execution of a media application by the mobile device; identifying first media content using the media application; identifying a first target rendering device of the rendering devices in the home network wherein the renderer selection control/indication identifies the first target rendering device to a user of the mobile device; accepting user input on the user interface of the mobile device which selects the media transfer control; rendering the first media content on the first target rendering device in response to selection of the media transfer control; and indicating to the user of the mobile device that the first target rendering device is rendering the first media content wherein the media transfer indication indicates to the user of the mobile device that the first target rendering device is rendering the first media content.

In an embodiment, the method has the step of displaying playback controls, the media transfer control, the media transfer indication and the renderer selection control/indication concurrently in the user interface of the mobile device wherein the playback controls enable the user of the mobile device to control rendering of the first media content on the first target rendering device.

In an embodiment, the method has the step of displaying a webpage in the user interface of the mobile device wherein the first media content is identified as internet media content selected from the webpage by the user of the mobile device.

In an embodiment, the method has the step of obtaining the first media content from a media server located in the home network in response to the selection of the media transfer control wherein the first target rendering device obtains the first media content from the media server in response to the selection of the media transfer control without the mobile device transmitting the first media content to the first target rendering device.

In an embodiment, the method has the step of transmitting the first media content from local storage on the mobile device to the first target rendering device in response to the selection of the media transfer control.

In an embodiment, the method has the step of transmitting the first media content from a remote content provider connected to the mobile device by a network which is a different network than the home network wherein the remote content provider transmits the first media content to the mobile device using the network and the mobile device transmits the first media content to the first target rendering device using the home network in response to the selection of the media transfer control.

In an embodiment, the method has the step of graphically connecting the media transfer control and the renderer selection control/indication using the media transfer indication while the first target rendering device is rendering the first media content.

In an embodiment, the method has the step of automatically identifying the first target rendering device from the rendering devices in the home network in response to identification of the first media content wherein the mobile device identifies the first target rendering device in response to the identification of the first media content without selection of the first target rendering device by the user after the identification of the first media content and further wherein the first target rendering device has media capabilities which correspond to the first media content.

In an embodiment, the method has the steps of accepting a series of user input events on the mobile device over a time period wherein each of the user input events in the series cause changes to a set of media content selected in the media application; and periodically updating a representation of a current target rendering device to reflect the changes to the set of media content selected in the media application wherein the renderer selection control/indication displays the representation of the current target rendering device and further wherein the representation of the current target rendering device identifies the first target rendering device when the first media content is selected in the media application.

In an embodiment, the method has the steps of identifying a second target rendering device of the rendering devices in the home network wherein the renderer selection control/indication identifies the second target rendering device to the user of the mobile device before identification of the first target rendering device wherein the first target rendering device and the second target rendering device are both capable of rendering the first media content; and detecting unavailability of the second target rendering device wherein the mobile device detects the unavailability of the second target rendering device wherein the renderer selection control/indication identifies the first target rendering device to the user in response to detection of the unavailability of the second target rendering device.

In an embodiment, the media transfer control and the media transfer indication are a single functional element provided by the user interface of the mobile device and further wherein the single functional element provides the media transfer control and the media transfer indication.

In an embodiment, the media transfer control, the media transfer indication and the renderer selection control/indication are a single functional element provided by the user interface of the mobile device and further wherein a user of the mobile device uses a first invocation of the single functional element to select the media transfer control and uses a second invocation of the single functional element to select the renderer selection control/indication wherein the user interface displays a list of available rendering devices in the home network in response to selection of the renderer selection control/indication and further wherein the first invocation and the second invocation select the single functional element in different ways.

In an embodiment, the method has the step of replacing the media transfer indication with an error indication in response to an error preventing the first target rendering device from rendering the first media content after selection of the media transfer control wherein the error indication indicates that the first target rendering device cannot render the first media content.

In an embodiment, the method has the step of replacing the renderer selection control/indication with error information in response to an error preventing the first target rendering device from rendering the first media content after selection of the media transfer control wherein the error information describes the error.

In an embodiment, the method has the step of replacing the media transfer control with an error correction control wherein selection of the error correction control by user input in the user interface of the mobile device enables correction of an error preventing the first target rendering device from rendering the first media content.

In an embodiment, the method has the step of selecting the media transfer control on the mobile device after initiating rendering of the first media content on the first target rendering device wherein selecting the media transfer control after initiating rendering of the first media content on the first target rendering device discontinues rendering of the first media content on the first target rendering device.

In another embodiment of the present invention, a method for transferring media content from a mobile device to a home network is provided. The mobile device has a user interface, and the home network has rendering devices. The method has the steps of displaying a media transfer control and a renderer selection control/indication concurrently in the user interface of the mobile device during execution of a media application by the mobile device wherein the renderer selection control/indication visually indicates a first target rendering device; identifying the media content using the media application; accepting first user input in the user interface of the mobile device wherein the first user input selects the renderer selection control/indication; displaying a list of available rendering devices in the home network wherein the user interface of the mobile device displays the list in response to selection of the renderer selection control/indication; accepting second user input in the user interface of the mobile device wherein the second user input selects a second target rendering device from the list of available rendering devices; and rendering the media content on the second target rendering device.

In an embodiment, the method has the step of indicating the rendering devices in the home network which have media capabilities which correspond to the media content wherein the list of available rendering devices indicates the rendering devices in the home network which have the media capabilities which correspond to the media content.

In an embodiment, the method has the step of indicating the rendering devices in the home network which have media capabilities which do not correspond to the media content wherein the list of available rendering devices indicates the rendering devices in the home network which do not have the media capabilities which correspond to the media content.

In an embodiment, the method has the step of automatically identifying the first target rendering device from the rendering devices in the home network before the renderer selection control/indication visually indicates the first target rendering device wherein the mobile device identifies the first target rendering device without selection of the first target rendering device by the user.

In an embodiment, the media transfer control and the renderer selection control/indication are a single functional element provided by the user interface of the mobile device and further wherein the single functional element provides the media transfer control and the renderer selection control/indication.

In an embodiment, the method has the step of providing renderer setting controls with the list of available rendering devices wherein the user interface of the mobile device displays the renderer setting controls in response to selection of the renderer selection control/indication and further wherein the renderer setting controls enable a user of the mobile device to establish settings associated with each of the available rendering devices wherein a user of the mobile device establishes the settings for the second target rendering device before the second user input and further wherein the second target rendering device implements the settings during rendering of the media content.

In an embodiment, the method has the step of changing the renderer selection control/indication from a first icon to a second icon in response to selection of the second rendering device wherein the second icon visually indicates the second target rendering device.

In an embodiment, the method has the step of accepting third user input in the user interface of the mobile device wherein the third user input selects the media transfer control and further wherein the rendering of the media content on the second target rendering device is initiated in response to selection of the media transfer control.

In another embodiment of the present invention, a system for transferring media content to rendering devices in a home network using a mobile device is provided. The system has a media application executing on the mobile device wherein the media application enables a user to identify selected media content; a media transfer control which enables the user to identify a selected mode of operation from a first mode of operation and a second mode of operation wherein the first mode of operation transfers the selected media content to one or more of the rendering devices in the home network and further wherein the second mode of operation does not transfer the selected media content to any of the rendering devices in the home network; a media transfer indication which visually indicates the selected mode of operation; and a renderer selection control/indication which visually indicates a target rendering device from the rendering devices in the home network and which enables the user to change the target rendering device wherein the first mode of operation transfers the selected media content to the target rendering device.

In an embodiment, the system has a user interface of the mobile device wherein the media transfer control, the media transfer indication, and the renderer selection control/indication are concurrently displayed in the user interface during execution of the media application.

In an embodiment, the system has a plurality of media applications executable on the mobile device wherein each of the plurality of media applications enables the user to identify the selected media content and further wherein each of the plurality of media applications provides the media transfer control, the media transfer indication and the renderer selection control/indication.

In an embodiment, the media transfer control and the media transfer indication are a single functional element provided by the mobile device and further wherein the single functional element provides the media transfer control and the media transfer indication.

In an embodiment, the media transfer indication and the renderer selection control/indication are a single functional element provided by the mobile device and further wherein the single functional element provides the media transfer indication and the renderer selection control/indication.

In an embodiment, the media transfer control, the media transfer indication and the renderer selection control/indication are a single functional element provided by the mobile device and further wherein the single functional element provides the media transfer control, the media transfer indication and the renderer selection control/indication.

In an embodiment, the mobile device automatically identifies the target rendering device from the rendering devices in the home network in response to identification of the selected media content by the user and further wherein the mobile device identifies the target rendering device without selection of the target rendering device by the user after the identification of the selected media content wherein the target rendering device has media capabilities which correspond to the selected media content.

In an embodiment, a first rendering device and a second rendering device of the rendering devices in the home network are capable of rendering the selected media content and further wherein the renderer selection control/indication identifies the first rendering device as the target rendering device to the user of the mobile device wherein the mobile device detects unavailability of the first rendering device after identifying the first rendering device as the target rendering device and further wherein the renderer selection control/indication identifies the second rendering device as the target rendering device to the user in response to detection of the unavailability of the first target rendering device.

In an embodiment, the system has a list of the rendering devices in the home network wherein the list is displayed in response to user input which selects the renderer selection/control indication and further wherein the user changes the target rendering device using the list.

In an embodiment, the system has an error indication visually indicated by one of the media transfer indication and the renderer selection control/indication wherein the media transfer control provides at least one option to correct an error indicated by the error indication.

It is, therefore, an advantage of the present invention to provide a system and a method for transferring media content from a mobile device to a home network.

Another advantage of the present invention is to provide a system and a method for transferring media content from a mobile device to a home network which display persistent, visible controls on the mobile device for rendering the media content on a rendering device in the home network.

And, another advantage of the present invention is to provide a system and a method for transferring media content from a mobile device to a home network which use the mobile device to display persistent, visible status of rendering of the media content by a rendering device in the home network.

Yet another advantage of the present invention is to provide a system and a method for transferring media content from a mobile device to a home network which present controls and status in a media application executed by the mobile device.

Still further, an advantage of the present invention is to provide a system and a method for transferring media content from a mobile device to a home network which enable a user to use the mobile device to start and stop external rendering of the media content currently selected in a media application executed by the mobile device.

And, another advantage of the present invention is to provide a system and a method for transferring media content from a mobile device to a home network which provide controls on the mobile device to enable a user to select a rendering device.

Yet another advantage of the present invention is to provide a system and a method for transferring media content from a mobile device to a home network which use the mobile device to indicate a target rendering device appropriate for the media content currently selected in a media application on the mobile device.

Still further, an advantage of the present invention is to provide a system and a method for transferring media content from a mobile device to a home network which use the mobile device to indicate and/or correct a network problem which prevents external rendering.

And, another advantage of the present invention is to provide a system and a method for transferring media content from a mobile device to a home network which combine controls and status on the mobile device in a compact, minimal form.

Still further, an advantage of the present invention is to provide a system and a method for transferring media content from a mobile device to a home network which use the same presentation of controls and status in multiple media applications on a mobile device.

Another advantage of the present invention is to provide a system and a method for transferring media content from a mobile device to a home network which remove the need for a user to select a rendering device.

Yet another advantage of the present invention is to provide a system and a method for transferring media content from a mobile device to a home network which enables a user to send the media content from an application on the mobile device to an external rendering device by invoking a single control in a single step on the mobile device.

Still further, an advantage of the present invention is to provide a system and a method for transferring media content from a mobile device to a home network which minimize the delay to send the media content from an application on the mobile device to an external rendering device.

Another advantage of the present invention is to provide a system and a method for transferring media content from a mobile device to a home network which control transfer of the media content using a compact arrangement of one, two, or three functional elements displayed on the mobile device.

Yet another advantage of the present invention is to provide a system and a method for transferring media content from a mobile device to a home network which add a set of controls and indications to any media application on the mobile device.

Still further, an advantage of the present invention is to provide a system and a method for transferring media content from a mobile device to a home network which continuously update an indication of a current target rendering device based on changes in the media content, changes in available rendering devices, and settings and preferences established by a user.

Another advantage of the present invention is to provide a system and a method for transferring media content from a mobile device to a home network which supplement a generic mobile device media application which lacks media transfer and sharing capabilities with a set of controls and indications for media transfer and sharing.

Moreover, an advantage of the present invention is to provide a system and a method for transferring media content from a mobile device to a home network which provide an intuitive picture of media flowing from a media transfer control to a target rendering device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a system for transferring media content from a mobile device to a home network in an embodiment of the present invention.

FIG. 2 illustrates a user interface of a media application having a set of controls and indications in an embodiment of the present invention.

FIGS. 3-5 illustrate sets of controls and indications in embodiments of the present invention.

FIG. 6 illustrates a renderer menu in an embodiment of the present invention.

FIGS. 7A, 7B and 7C illustrate sets of controls and indications in embodiments of the present invention.

FIG. 8 illustrates a user interface of a prior art image viewer application.

FIGS. 9 and 10 illustrate user interfaces of an image viewer application in embodiments of the present invention.

FIG. 11 illustrates a user interface of a video player application in an embodiment of the present invention.

FIG. 12 illustrates a user interface of a music player application in an embodiment of the present invention.

### DETAILED DESCRIPTION OF THE PREFERRED EMBODIMENTS

The present invention generally relates to a system and a method for transferring media content from a mobile device to a home network. More specifically, the present invention relates to a system and a method which enable a media application on the mobile device to share media content with rendering devices in the home network. The system and the method provide a compact set of controls and indications which may enable a user to enable and disable transfer of the media content from the media application to a target rendering device. Further, the compact set of controls and indications may visually indicate the target rendering device and whether the media content is currently being transferred. Still further, the compact set of controls and indications may enable the user to select a new target rendering device. Moreover, the compact set of controls and indications may indicate network errors or other problems which may prevent the rendering of the media content and may enable the user to correct the network errors or the other problems.

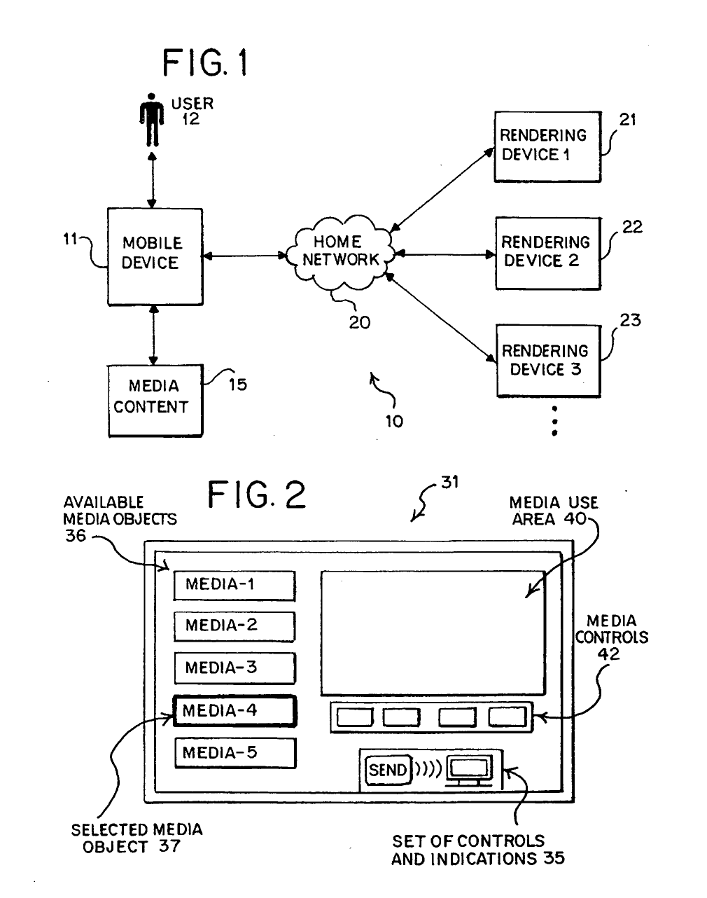

Referring now to the drawings wherein like numerals refer to like parts, FIG. 1 generally illustrates a system 10 for transferring media content 15 from a mobile device 11 to a home network 20, such as, for example, a residential local area network, in an embodiment of the present invention. The mobile device 11 may connect to and/or may communicate with one or more available rendering devices using the home network 20. For example, the mobile device 11 may be connected to a first rendering device 21, a second rendering device 22 and/or a third rendering device 23 (collectively hereinafter “the rendering devices 21,22,23”) using the home network 20. The mobile device 11 may be any mobile device which may be capable of connecting to the available rendering devices, such as, for example, the rendering devices 21,22,23, using the home network 20. For example, the mobile device 11 may be a portable music player, a portable video player, a portable gaming device, a personal digital assistant (PDA), a mobile telephone, a laptop PC, a netbook PC and/or the like. The mobile device 11 may have a display screen capable of displaying user interface elements and/or visual media content. Typically, a size of the display screen may be limited by a physical size of the mobile device 11. The mobile device 11 may have one or more local audio rendering capabilities. For example, the mobile device 11 may have an internal speaker, a headphone jack, an audio output jack, and/or the like. The present invention is not limited to a specific embodiment of the mobile device 11.

The mobile device 11 may have a user interface by which a user 12 may interact with and/or may control the mobile device 11. Visual elements of the user interface may be displayed on the display screen of the mobile device 11. The user 12 may interact with the mobile device 11 and/or the user interface based on one or more user input methods provided by the mobile device 11. For example, the mobile device 11 may have a touchscreen, a trackball, a joystick, a five-way navigation pad, a 4-way directional pad, a numeric keypad, an alphanumeric keyboard, softkeys, buttons, orientation sensors and/or the like. The present invention is not limited to a specific embodiment of the user input methods which may be provided by the mobile device 11.

The home network 20 may utilize one or more network connection technologies, such as, for example, IEEE 802.11 (“WiFi”), IEEE 802.3 (“Ethernet”), IEEE 1394 (“FireWire”) and/or the like. The home network 20 may connect to and/or may communicate with other devices not shown in FIG. 1, such as, for example, personal computers, laptop computers, media servers and/or the like. The home network 20 may provide a connection to other networks, such as, for example, the internet.

The available rendering devices, such as, for example, the rendering devices 21,22,23, may support one or more multimedia home networking standards, such as, for example, UPnP AV and/or DLNA. The available rendering devices may be, for example, a television, a set-top box, a digital photo frame, a stereo, an audio receiver box, a gaming console, a personal computer, a laptop PC, a netbook PC, and/or the like. The available rendering devices may be any rendering device capable of rendering the media content received using the home network 20 as known to one skilled in the art, and the present invention is not limited to a specific embodiment of the available rendering devices.

The mobile device 11 may have access to the media content 15. The media content 15 may be stored locally on the mobile device 11. For example, the media content 15 may reside in internal memory of the mobile device 11, on an internal disk, and/or on a removable storage card connected to the mobile device 11. The media content 15 may be stored remotely relative to the mobile device 11. For example, the media content 15 accessed by the mobile device 11 may be media content stored on one or more servers in the home network 20. As another example, the media content 15 accessed by the mobile device 11 may be media content stored outside of the home network 20 and/or accessed using a network connection. The mobile device 11 may access the media content 15 using the internet. The mobile device 11 may obtain the media content 15 from one or more content services which may be freely available and/or may require a subscription. The present invention is not limited to a specific means by which the mobile device 11 may access the media content 15.

The mobile device 11 may have one or more media applications. The media application may be a built-in function, a built-in application, an installed application, a user-installed application and/or the like. The media application may enable the user 12 to create, access, identify, select, organize, manage, manipulate, use and/or render the media content 15 using the mobile device 11. The media application may be any application in which a set of the media content 15 may be identified, may be selected and/or may be used. Hereinafter, the term “media in context” denotes a set of one or more media content objects of the media content 15 which are currently identified, selected, and/or in use in the media application. The media application may identify, may select and/or may use the media content 15 regardless of whether a rendering device is accessible using the home network 20. The media application may be provided by and/or stored by a computer readable medium, such as, for example, a compact disc, a DVD, a computer memory, a hard drive and/or the like. The computer readable medium may enable the laptop PC, the netbook PC and/or the like to execute the media application.

The media content 15 may be, for example, image content, video content, audio content and/or the like. The image content may be, for example, digital photographs, bitmap images, vector graphics images, image files and/or the like. The video content may be, for example, digital video streams, digital video files, video clips, television programs, movies, music videos, instructional videos and/or the like. The audio content may be, for example, digital music files, music streams, recorded audio, encoded speech, synthetic audio files, music compositions, ringtones and/or the like. The present invention is not limited to a specific embodiment of the media content 15, and the media content 15 may be any media content accessible to the mobile device 11 known to one having ordinary skill in the art.

FIG. 2 generally illustrates a user interface 31 of the media application in an embodiment of the present invention. FIG. 2 also generally illustrates functional elements which may be provided by the user interface 31 of the media application. An appearance, an arrangement, an organization and/or a layout of the functional elements and the user interface 31 may differ between media applications, and the present invention is not limited to a specific embodiment of the appearance, the arrangement, the organization and/or the layout of the functional elements or the user interface 31 of the media application.

The media application may provide access to a set of available media content objects and/or may enable the user 12 to select one or more of the available media content objects. As shown in FIG. 2, the media application may display symbolic representations 36 of the available media content objects in the user interface 31 of the media application. As shown in FIG. 2, the user interface 31 of the media application may display a selected symbolic representation 37 for one or more selected media objects. In an embodiment, the media application may not display the symbolic representations 36 of the media objects and/or the selected symbolic representation 37 for the selected media objects. In an embodiment, the media application may display the symbolic representations 36 only in certain screens, views, or stages of use of the media application. The minimal requirement for the media application is that the media application must be capable of having the “media in context” as previously defined. Thus, the “media in context” for the media application of FIG. 2 may be one or more selected media objects, may be the available media objects and/or may be some other set of media objects relevant to the user 12.

The user interface 31 of the media application may have a media use area 40. The media use area 40 may enable the user 12 to create, organize, arrange, manage, manipulate, use and/or play the media content 15 using the mobile device 11. For example, the media use area 40 may be an image viewing area; a video playback area; an area providing metadata associated with one or more audio media content objects; a playlist editing area; an area for arranging media content into folders, favorites, or other organizational structures; and/or the like. The media use area 40 may be an area for browsing, searching, discovering and/or selecting the media content 15. The media use area 40 may enable the user 12 to create, edit, and/or modify the media content 15. The media use area 40 may be any area for using the media content 15 as known to one having ordinary skill in the art, and the present invention is not limited to a specific embodiment of the media use area 40.

The user interface 31 of the media application may have media controls 42. The media controls 42 may enable the user 12 to control media-related tasks, such as, for example, creation, discovery, selection, organization, management, manipulation and/or rendering of the media content 15. The media controls 42 may vary between media applications because of the specialized nature of specific media applications. The present invention is not limited to a specific embodiment of the media controls 42.

The user interface 31 of the media application may have a set of controls and indications 35 as illustrated in FIG. 2. The set of controls and indications 35 may enable the user 12 to enable and/or disable transfer of the media content 15 from the media application to a target rendering device of the available rendering devices, such as, for example, the rendering devices 21,22,23. Further, the set of controls and indications 35 may visually indicate the target rendering device and/or may visually indicate whether the media content 15 is currently being transferred. Still further, the set of controls and indications 35 may enable the user 12 to select a new target rendering device of the available rendering devices, such as, for example, the rendering devices 21,22,23. Moreover, the set of controls and indications 35 may indicate network errors and/or other problems which may prevent the rendering of the media content 15 and/or may enable the user 12 to correct the network errors and/or the other problems.

The media application may be, for example, an image viewer, a video player, a music player, an internet radio player, a media management application, a camera application, an audio recording application, a photo organization application, a photo album editor, a music playlist editor, a video editor, and/or the like. The media application may be a web browser application capable of identifying media content which may be rendered and/or may be contained in and/or accessible through web pages retrieved by the web browser application. The media application may be a media service application designed to provide access to media content from one or more associated content services. The present invention is not limited to a specific embodiment of the media application, and the media application may be any application capable of creating, accessing, identifying, selecting, playing, rendering and/or using the media content 15 on the mobile device 11.

As a first example of use of the set of controls and indications 35, the media application may be an image viewer application which may enable digital photographs and/or other images stored on the mobile device 11 to be viewed, selected, arranged and/or organized on the display screen of the mobile device 11. The image viewer application may enable the user 12 to display a single image and/or a slideshow of multiple images on the display screen of the mobile device 11. The user 12 may use the set of controls and indications 35 to enable transfer of the media content 15 from the image viewer application to a target rendering device of the available rendering devices, such as, for example, the rendering devices 21,22,23. As a result, the single image and/or the slideshow displayed on the display screen of the mobile device 11 may transfer to the target rendering device for rendering. An additional image and/or an additional slideshow may be transferred from the image viewer application to the target rendering device based on user selection of the additional image and/or the additional slideshow within the user interface 31 of the image viewer application. If transfer of the media content 15 is enabled using the set of controls and indications 35, images and/or slideshows selected and/or displayed using the user interface 31 of the image viewer application may transfer from the image viewer application to the target rendering device for display. The user 12 may use the set of controls and indication 35 to disable transfer of the media content 15 from the image viewer application to the target rendering device. As a result, an image and/or a slideshow subsequently selected and/or subsequently displayed by the user interface 31 of the image viewer application may not transfer to the target rendering device.

As a second example of use of the set of controls and indications 35, the media application may be a music player application which may enable music files accessible by the mobile device 11 to be identified, organized, arranged into playlists and/or rendered using the mobile device 11. The user 12 may use the set of controls and indications 35 to enable transfer of the media content 15 from the music player application to a target rendering device of the available rendering devices, such as, for example, the rendering devices 21,22,23. As a result, music files and/or playlists selected, used and/or played in the music player application may transfer to the target rendering device for rendering. The user 12 may use the media controls 42 of the user interface 31 of the music player application to identify, organize, arrange, and/or play additional music files. As a result, the additional music files may transfer from the music player application to the target rendering device for rendering. The user 12 may use the media controls 42 to control the rendering by the target rendering device. For example, the media controls 42 may enable the user 12 to pause, play, rewind, fast forward, skip to a previous music file, skip to a next music file and/or the like. The media controls 42 may control rendering of music files on the mobile device 11 if the transfer of the media content 15 to the target rendering device is disabled using the set of controls and indications 35. The media controls 42 may control the rendering of the music files on the target rendering device if the transfer of the media content 15 to the target rendering device is enabled using the set of controls and indications 35. The user 12 may use the set of controls and indications 35 to disable the transfer of the media content 15 from the music player application to the target rendering device. As a result, music files and/or playlists subsequently selected, used and/or played in the music player application may not transfer to the target rendering device for rendering.

As a third example of use of the set of controls and indications 35, the media application may be a web browser application which may enable the user 12 to browse web pages. The web pages may contain internet media content which may be rendered, may be identifiable and/or may be retrievable by the web browser application. The web browser application may enable the user 12 to select the internet media content from one or more displayed web pages to form the “media in context.” The user 12 may use the set of controls and indications 35 to enable transfer of the “media in context” to a target rendering device of the available rendering devices, such as, for example, the rendering devices 21,22,23. As a result, the “media in context” may transfer from the web browser application to the target rendering device for rendering. The web browser application may provide the media controls 42 for controlling the rendering of the media content 15 on the target rendering device. For example, the web browser application may provide video playback controls, such as, for example, pause, play, fast forward, rewind, stop and/or the like. The user 12 may browse additional web pages, and/or the user 12 may select additional media content accessible using the additional web pages. Thus, the user 12 may add to and/or may change the “media in context.” The additional media content selected by the user 12 may transfer from the web browser application to the target rendering device for rendering. The user 12 may use the set of controls and indications 35 to disable transfer of the media content from the web browser application to the target rendering device. As a result, the transfer of the media content to the target rendering device may be stopped, and/or the media content subsequently selected in the web browser application may not transfer to the target rendering device for rendering.

Accordingly, the set of controls and indications 35 may be used to enable, disable, direct and/or configure the transfer of the media content to a target rendering device. However, the transfer of the media content may or may not originate from and/or flow through the mobile device 11. If the “media in context” in the media application is locally stored on the mobile device 11, the media content may be transferred from the mobile device 11 to the target rendering device using the home network 20. Alternatively, if the “media in context” in the media application is not stored locally on the mobile device 11, the media content may or may not flow through the mobile device 11 if the transfer of the media content to a target rendering device is enabled using the set of controls and indications 35.

For example, the mobile device 11 may access and/or obtain the media content from a remote content service using a 3G carrier network for use in a media application on the mobile device 11. Then, the mobile device 11 may relay the media content to the target rendering device using the home network 20. In this case, the media content from the remote content service may flow through the mobile device 11 if the transfer of the media content is enabled using the set of controls and indications 35.

In another example, the mobile device 11 may access the media content stored on a media server in the home network 20 for use in a media application on the mobile device 11. In this case, the mobile device 11 may instruct the target rendering device to obtain the media content directly from the media server in the home network 20 if the transfer of the media content is enabled using the set of controls and indications 35.

In either example, the mobile device 11 may act as a Control Point to control the rendering of the media content on the target rendering device based on user input on the mobile device 11.

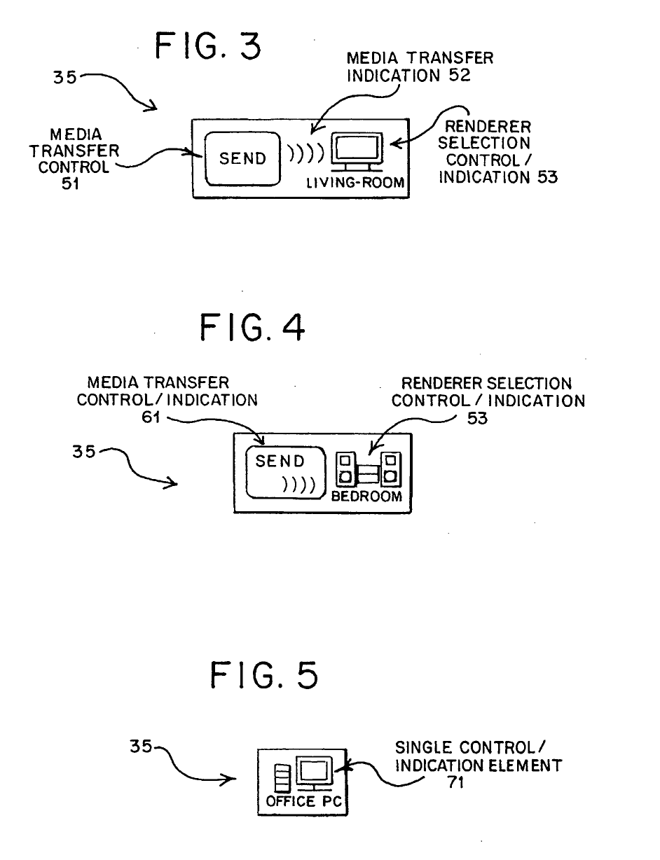

FIGS. 3, 4, and 5 provide general illustrations of the set of controls and indications 35 in embodiments of the present invention. The form of the various control and/or indication elements presented in these figures and in the other figures herein may vary by embodiment. As a first example, a control and/or indication element may be a touchable button displayed on a touchscreen embodiment of the user interface 31. As a second example, a control and/or indication element may be a softkey option which may display a graphic indication which may be invoked by pressing a physical softkey button on the mobile device 11. As a third example, a control and/or indication element may be invoked using a corresponding dedicated physical button on the mobile device 11. As a fourth example, a control and/or indication element may be an element of the user interface 31 which may be capable of being selected, such as, for example, using a trackball, a directional pad, a 5-way navigation pad, an up-down scroll wheel and/or another pointing and/or selection mechanism which may be provided by the mobile device 11. The present invention is not limited to a specific embodiment of the control and/or indication elements, and one having ordinary skill in the art will recognize various other means by which such user interface elements may be displayed, may be presented, may be selected and/or may be invoked.

FIG. 3 generally illustrates the set of controls and indications 35 in an embodiment of the present invention. As shown in FIG. 3, the set of controls and indications 35 may have at least three functional elements which may be presented in close proximity to each other in the user interface 31 of the media application. The three functional elements may be a media transfer control 51, a media transfer indication 52, and a renderer selection control/indication 53. The set of controls and indications 35, such as, for example, the media transfer control 51, the media transfer indication 52, and/or the renderer selection control/indication 53, may be visible in the user interface 31 and/or may be invoked by the user 12.

The media transfer control 51 may be used to enable and/or disable the transfer of the media content 15 from the media application to the target rendering device in the home network 20. If the transfer of the media content 15 is possible but is currently disabled, the user 12 may invoke the media transfer control 51 to enable the transfer of the media content 15 from the media application to the target rendering device. As a result, the “media in context” in the media application may transfer to the target rendering device for rendering. If the transfer of the media content 15 is currently enabled, the user 12 may invoke the media transfer control 51 to disable the transfer of the media content 15 from the media application to the target rendering device. As a result, the transfer of the media content 15 to the target rendering device may be stopped, and/or the target rendering device may stop rendering the media content 15.

The media transfer control 51 may be represented in the user interface 31 of the media application by a visual representation, such as, for example, text, a graphic symbol and/or an icon, a combination of text and graphics, and/or the like. As depicted in FIG. 3, the media transfer control 51 may be labeled with the word “Send” and/or another text label. For example, the media transfer control 51 may be labeled with “Transfer,” “Play To,” “Beam,” “Share,” “Render” and/or another text label. The present invention is not limited to a specific embodiment of the visual representation of the media transfer control 51.

In an embodiment, an appearance of the media transfer control 51 may change based on whether the transfer of the media content 15 from the media application is currently enabled or disabled. For example, if the transfer of the media content 15 is disabled, the appearance of the media transfer control 51 may indicate that invocation of the media transfer control 51 will enable the transfer of the media content 15. If the transfer of the media content 15 is enabled, the appearance of the media transfer control 51 may indicate that invocation of the media transfer control 51 will disable the transfer of the media content 15. In an embodiment generally illustrated in FIG. 3, the media transfer control 51 may be labeled with “Send” and/or a similar term if the transfer of the media content 15 is disabled, and/or the media transfer control 51 may instead be labeled with “Stop Sending” and/or a similar term if the transfer of the media content 15 is enabled.

The media transfer indication 52 may provide a visual indication of the state of the transfer of the media content 15 from the media application to the target rendering device. The media transfer indication 52 may indicate the state of the transfer using text, a graphical depiction, a combination of text and a graphical depiction, and/or the like.

For example, the media transfer indication 52 may not have a text label if the transfer of the media content 15 is disabled, and/or the media transfer indication 52 may have a text label, such as, for example, “Sending . . . ” or “Beaming . . . ,” if the transfer of the media content 15 is enabled. As another example, the media transfer indication 52 may display a first graphic symbol if the transfer is disabled and/or a second graphic symbol which is a different symbol than the first symbol if the transfer is enabled. The first graphic symbol may be, for example, empty space, a “grayed out” version of the second graphic symbol, and/or the like. The second graphic symbol may be, for example, a connection wire, an arrow, a lightning bolt, a set of arcs, a set of emanating rays, and/or any graphic symbol indicative of the transfer of the media content 15 to the target rendering device. As yet another example, the media transfer indication 52 may be a graphic symbol which may be animated if the transfer of the media content 15 is enabled. For example, the media transfer indication 52 may flash, pulsate, change color, change size, rotate and/or otherwise move to indicate the transfer of the media content 15 to the target rendering device. The media transfer indication 52 may visually indicate a continuous directed flow of dots, objects, stripes, arcs, colors, materials, and/or the like. The present invention is not limited to a specific embodiment of the media transfer indication 52, and other text labels and/or other graphic representations may be used to indicate that the transfer of the media content 15 is disabled and/or enabled. One having ordinary skill in the art will recognize various other means by which the media transfer indication 52 may be displayed and/or presented.

The media transfer indication 52 may graphically connect the media transfer control 51 and the renderer selection control/indication 53, and/or the media transfer indication 52 may graphically indicate a flow from the media transfer control 51 to the renderer selection control/indication 53. Thus, the media transfer indication 52 may indicate to the user 12 that the media content 15 may be flowing from the media transfer control 51 which may represent a source of the transfer to the renderer selection control/indication 53 which may represent the target rendering device.

The renderer selection control/indication 53 may provide a graphic indication of a currently selected target rendering device, if any. Thus, if the transfer of the media content 15 is currently disabled, the user 12 may use the appearance of the renderer selection control/indication 53 to determine whether further action may be needed to select a target rendering device. If an appropriate target rendering device is already indicated, the user 12 may invoke the media transfer control 51 without a need to select a target rendering device. If the user 12 determines that selection of a target rendering device is necessary, the user 12 may invoke the renderer selection control/indication 53 to access a list of available rendering devices as described in more detail hereafter.

The form of the media transfer control 51 and/or the renderer selection control/indication 53 and the method by which the user 12 may invoke the media transfer control 51 and/or the renderer selection control/indication 53 may vary by embodiment. As a first example, the media transfer control 51 and/or the renderer selection control/indication 53 may be a touchable button displayed on a touchscreen embodiment of the user interface 31. As a second example, the media transfer control 51 and/or the renderer selection control/indication 53 may be a softkey option which may be invoked by pressing a corresponding physical softkey button on the mobile device 11. As a third example, the media transfer control 51 and/or the renderer selection control/indication 53 may be invoked using a corresponding dedicated physical button on the mobile device 11. As a fourth example, the media transfer control 51 and/or the renderer selection control/indication 53 may be an element of the user interface 31 which may be capable of selection. For example, the media transfer control 51 and/or the renderer selection control/indication 53 may be selected using a trackball, a directional pad, a 5-way navigation pad, an up-down scroll wheel and/or another pointing and/or selection mechanism which may be provided by the mobile device 11. The present invention is not limited to a specific embodiment of the media transfer control 51 and the renderer selection control/indication 53, and one having ordinary skill in the art will recognize other means by which the media transfer control 51 and the renderer selection control/indication 53, may be displayed, presented, selected, and/or invoked.

The renderer selection control/indication 53 may indicate the current target rendering device using a text label, a graphic symbol or icon, a combination of text and graphics, and/or the like. As shown in FIG. 3, a graphic depiction of a television may be combined with a text label to indicate that the current rendering device is a television located in the living room. The user 12 may invoke the media transfer control 51 to enable the transfer of the “media in context” from the media application to the living room television. Alternatively, the user 12 may invoke the renderer selection control/indication 53 to select a different target rendering device.

The renderer selection control/indication 53 may have a form which may indicate that no target rendering device is available and/or currently selected. For example, the renderer selection control/indication 53 may have an empty box, a question mark, an “X” and/or a similar symbol in the absence of a target rendering device. Alternatively or additionally, the renderer selection control/indication 53 may display a text label, such as, for example, “No Renderer,” to indicate that no target rendering device is currently available and/or selected.

In a preferred embodiment, the set of controls and indications 35 may display a representation of an appropriate target rendering device regardless of whether the user 12 has selected a target rendering device. For example, the set of controls and indications 35 may display a representation of an available target rendering device which may be appropriate for the “media in context” of the media application. If the user 12 selects a photo slideshow in the media application, the set of controls and indications 35 may display a representation of an available rendering device appropriate for displaying a photo slideshow. If the user 12 selects a music album in the media application, the set of controls and indications 35 may display a representation of an available rendering device appropriate for playing music. If multiple available rendering devices are appropriate for the “media in context,” the set of controls and indications 35 may display a representation of a preferred rendering device from the available rendering devices appropriate for the “media in context.” The preferred rendering device may be selected based on settings and/or preferences configurable by the user 12, a number of times the available rendering devices were previously selected and/or used, which available rendering devices were recently used, and/or the like. The present invention is not limited to a specific method of determining the preferred rendering device for the “media in context.”

In an embodiment, the set of controls and indications 35 may periodically update the representation of the current target rendering device to reflect changes to the “media in context” in the media application. For example, if the media application is a slideshow editor, and/or the user 12 creates a slideshow having only digital photographs, the set of controls and indications 35 may display a representation of a digital photo frame capable of displaying the digital photographs as the target rendering device. Subsequently, the user 12 may add audio background music to the slideshow. The set of controls and indications 35 may determine that the digital photo frame is not capable of rendering the audio background music. As a result, the set of controls and indications 35 may update the renderer selection control/indication 53 to indicate that the target rendering device was changed to a digital television capable of rendering the slideshow having both the digital photographs and the audio background music. Thus, the set of controls and indications 35 may adapt to changes in the “media in context.”

In an embodiment, the set of controls and indications 35 may periodically update the representation of the target rendering device based on the available rendering devices. Rendering devices may be added to and/or may be removed from the home network 20, and the mobile device 11 may identify the additions and/or the deletions. For example, the mobile device 11 may use the standard UPnP discovery protocol to determine changes to the available rendering devices. If the current target rendering device becomes unavailable, the set of controls and indications 35 may indicate a change to a different target rendering device and/or may indicate that no appropriate target rendering device is available. If a new rendering device becomes available and/or may be preferable to the current target rendering device, the set of controls and indications 35 may indicate that the new rendering device is the target rendering device.

In different embodiments, the arrangement of the three functional elements may differ from that shown in FIG. 3. For example, the three functional elements may be arranged vertically rather than horizontally or may be arranged in a triangular shape. The order of the three functional elements within the set of controls and indications 35 may also vary based on the embodiment. The location of the set of controls and indications 35 in the user interface 31 of the media application may vary in different embodiments. The present invention is not limited to a specific arrangement or ordering of the three functional elements or to a specific location of the set of controls and indications 35 in the user interface 31 of the media application.

FIG. 4 generally illustrates the set of controls and indications 35 in an embodiment of the present invention. As shown in FIG. 4, the media transfer control 51 and the media transfer indication 52 may be combined into a single functional element, such as, for example, a media transfer control/indication 61. Thus, in an embodiment, the set of controls and indications 35 may have at least two functional elements, such as, for example, the media transfer control/indication 61 and the renderer selection control/indication 53. The two functional elements, such as, for example, the media transfer control/indication 61 and the renderer selection control/indication 53, may be displayed adjacent to each other in the user interface 31.

The media transfer control/indication 61 may be used to enable and/or disable the transfer of the media content 15 from the media application to a target rendering device in the home network 20. The media transfer control/indication 61 may have any property and/or may provide any function previously described for the media transfer control 51 and/or the media transfer indication 52. The media transfer control/indication 61 may provide a graphic indication of the state of the transfer of the media content 15 from the media application to the target rendering device. As generally illustrated in FIG. 4, a portion of the media transfer control/indication 61 may be used to indicate the state of the transfer, and the portion may have any property and/or any function previously described for the media transfer indication 52.

The media transfer control/indication 61 may change form to indicate the state of the transfer of the media content 15. For example, the media transfer control/indication 61 may pulsate, may move, may change colors, may glow, may animate and/or the like to indicate the transfer of the media content 15 from the media application to the target rendering device. As another example, the media transfer control/indication 61 may have a first static visual form to indicate that the transfer is disabled and a second static visual form which may be a different form than the first static visual form to indicate that the transfer is enabled. The present invention is not limited to a specific embodiment by which the media transfer control/indication 61 may indicate that the transfer is enabled and/or disabled.

The set of controls and indications 35 may have the renderer selection control/indication 53. As discussed previously, the renderer selection control/indication 53 may provide a graphic indication of the currently selected target rendering device, if any. If the user 12 determines that selection of a target rendering device is necessary, the user 12 may invoke the renderer selection control/indication 53 to access a list of available rendering devices as described in more detail hereafter.

FIG. 5 generally illustrates the set of controls and indications 35 in an embodiment of the present invention. As shown in FIG. 5, the set of controls and indications 35 may be combined into a single functional element, such as, for example, a single control/indication element 71. For example, the media transfer control 51, the media transfer indication 52 and the renderer selection control/indication 53 may be combined into the single control/indication element 71. The single control/indication element 71 may be presented and/or displayed in the user interface 31 of the media application.

The single control/indication element 71 may have a compact form which may enable a small display screen of the mobile device 11 to display the single control/indication element 71 without hindering display of the media content 15 on the display screen. Further, if space on the display screen is minimal because the user interface 31 of the media application has many interface elements, the compact form of the single control/indication element 71 may enable the mobile device 11 to display the single control/indication element 71.

In a preferred embodiment, the user interface 31 may present a first method for invoking the single control/indication element 71 and a second method for invoking the single control/indication element 71 which may be different methods for invoking the single control/indication element 71. The first method for invoking the single control/indication element 71 may invoke functions of the media transfer control 51. For example, the user 12 may use the first method for invoking the single control/indication element 71 to enable and/or disable the transfer of the media content 15 to the target rendering device. The second method for invoking the single control/indication element 71 may invoke functions of the renderer selection control/indication 53. For example, the user may use the second method for invoking the single control/indication element 71 to access a list of available rendering devices to specify a new target rendering device as described in more detail hereafter.

In a first example, the single control/indication element 71 may be presented as a touchable button displayed on a touch screen embodiment of the user interface 31. The first method for invoking the single control/indication element 71 may be to tap the touchable button, for example. By tapping the touchable button, the user 12 may enable and/or disable the transfer of the media content 15 to the target rendering device. The second method for invoking the single control/indication element 71 may be to press and hold the touchable button for a period of time, for example. By pressing and holding the touchable button for a period of time, the user 12 may access controls for selecting a new target rendering device from the available rendering devices. The controls for selecting a new target rendering device may be, for example, the functions of the renderer selection control/indication 53.

In a second example, the single control/indication element 71 may be displayed as a softkey option which may be invoked by pressing a corresponding physical key on the mobile device 11. The first method for invoking the single control/indication element 71 may be to tap the corresponding physical key, for example. By tapping the corresponding physical key, the user 12 may enable and/or disable the transfer of the media content 15 to the target rendering device. The second method for invoking the single control/indication element 71 may be to press and hold the corresponding physical key for a period of time, for example. By pressing and holding the corresponding physical key for a period of time, the user 12 may access the controls for selecting a new target rendering device from the available rendering devices. The controls for selecting a new target rendering device may be, for example, the functions of the renderer selection control/indication 53.

In a third example, the single control/indication element 71 may be displayed in the user interface 31 of the media application as an interface element which may be selected and/or may be “clicked” using a pointing mechanism. For example, the single control/indication element 71 may be selected and/or may be clicked using a trackball, a joystick, a 5-way navigation pad, a 4-way directional pad, a scroll wheel, a mouse and/or the like. The first method for invoking the single control/indication element 71 may be to “single-click” the single control/indication element 71, for example. By selecting and single-clicking the single control/indication element 71, the user 12 may enable and/or disable the transfer of the media content to the target rendering device. The second method for invoking the single control/indication element 71 may be to “double-click” the single control/indication element 71, for example. By selecting and double-clicking the single control/indication element 71, the user 12 may access the controls for selecting a new target rendering device from the available rendering devices. The controls for selecting a new target rendering device may be, for example, the functions of the renderer selection control/indication 53.

Although the single control/indication element 71 may use two different and distinguishable methods of invocation, the present invention is not limited to specific methods of invocation. One having ordinary skill in the art will recognize other means by which the single control/indication element 71 may be invoked in two or more different and distinguishable methods.

The appearance of the single control/indication element 71 may indicate the current target rendering device, if any. For example, the single control/indication element 71 may indicate the current target rendering device using a text label, a graphic symbol or icon, a combination of a text label and a graphic symbol or icon, and/or the like. The single control/indication element 71 may indicate that no target rendering device is currently selected and/or currently available.

As described previously for the renderer selection control/indication 53, the single control/indication element 71 may display a representation of an appropriate target rendering device regardless of whether the user 12 has selected a target rendering device. The single control/indication element 71 may update the target rendering device based on the “media in context” in the media application, based on identification of newly available and/or newly unavailable rendering devices in the home network 20, and/or the like. The single control/indication element 71 may display a representation for a target rendering device determined based on settings and/or preferences configurable by the user 12, the number of times the available rendering devices were previously selected and/or used, which available rendering devices were recently used, and/or the like. The present invention is not limited to a specific method of determining the target rendering device.

The single control/indication element 71 may indicate the state of the transfer of the media content 15 from the media application to the target rendering device. The single control/indication element 71 may indicate the state using text, a graphic depiction, a combination of text and a graphic depiction, a change in appearance of the single control/indication element 71, an animated appearance of the single control/indication element 71, and/or the like.

The single control/indication element 71 may have a first display style to indicate that the transfer of the media content 15 is disabled, and the single control/indication element 71 may have a second display style which may be a different style than the first display style to indicate that the transfer of the media content 15 is enabled. For example, the first display style may be “grayed out,” and/or the second display style may not be “grayed out.” As another example, the second display style may be highlighted relative to the first display style. As a third example, the second display style may be larger than the first display style.

The single control/indication element 71 may add a graphic element to the appearance of the single control/indication element 71 to indicate that the transfer of the media content 15 is enabled. For example, the single control/indication element 71 may add an arrow, a lightning bolt, a series of arcs, a set of emanating rays, a visible aura, and/or the like to indicate that the transfer of the media content 15 is enabled. The single control/indication element 71 may not display the graphic element and/or may display a different graphic element to indicate that the transfer of the media content 15 is disabled.

The single control/indication element 71 may use animation to indicate that the transfer of the media content 15 is enabled. For example, the single control/indication element 71 may be displayed in a static form if the transfer of the media content 15 is disabled and/or may be animated to indicate that media content 15 is transferring to the target rendering device. An animated graphic element may be added to the appearance of the single control/indication element 71 if the transfer of the media content 15 is enabled. Alternatively, the representation of the target rendering device in the single control/indication element 71 may be animated. The representation of the target rendering device may flash, may pulsate, may vibrate, may change colors, may move and/or the like to indicate that the media content 15 is transferring to and/or rendering on the target rendering device. For example, the representation of a stereo device may be animated to depict musical notes emanating from the speakers to indicate that the media content 15 is transferring to and/or rendering on the stereo device. As a second example, the representation of a television device may display a thumbnail version of the media content 15 to indicate that the media content 15 is transferring to and/or rendering on the television device.

In an embodiment, the media transfer indication 52 and the renderer selection control/indication 53 may be combined into a user interface element (not shown in the figures). Thus, the set of controls and indications 35 may be formed by the media transfer control 51 and the interface element which combines the media transfer indication 52 and the renderer selection control/indication 53. The interface element which combines the media transfer indication 52 and the renderer selection control/indication 53 may indicate the state of the transfer of the media content 15 and may provide the functions of the renderer selection control/indication 53.

In an embodiment, the media application may change a state of the media application. The media application may cause one or more of the media controls 42 to be invoked in response to user input, which selects and/or invokes the one or more of the media controls 42 in the set of controls and indications 35. For example, the media application may have an internal state for media playback on the mobile device 11, and/or the internal state may be set to “PLAY” to indicate that media content is playing on the mobile device 11 or set to “PAUSE” to indicate that the media playback is paused on the mobile device 11. The user 12 may enable transfer of the media content to a target rendering device by invoking the media transfer control 51, the media transfer control/indication 61 and/or the single control/indication element 71 when the media application has the internal state set to “PAUSE.” In response, the media application may change the internal state from “PAUSE” to “PLAY” and/or may take other actions associated with selection and/or invocation of a “play” control in the media controls 42. As a result, the media application may begin and/or may resume rendering of the media content on the mobile device 11 substantially simultaneously with the transfer to and/or the rendering of the media content on the target rendering device. In a similar fashion, the media application may change the internal state from “PLAY” to “PAUSE” in response to the user 12 disabling the transfer of the media content to the target rendering device by invoking the media transfer control 51, the media transfer control/indication 61 and/or the single control/indication element 71.

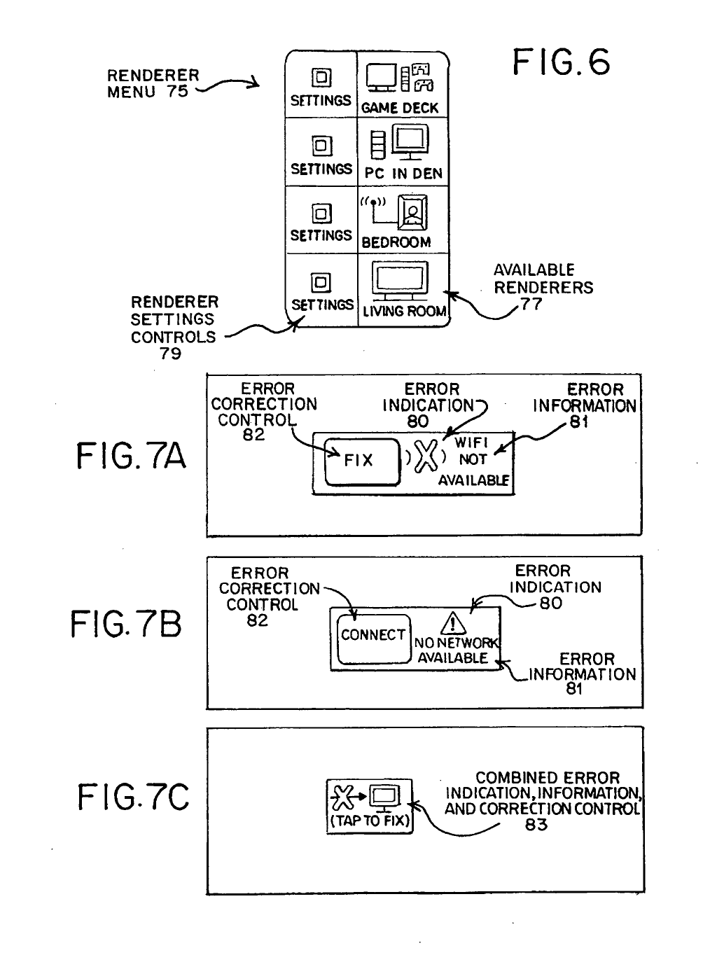

FIG. 6 generally illustrates a renderer menu 75 which may be displayed in the user interface 31 of the media application in an embodiment of the present invention. The renderer menu 75 may display a list 77 of available rendering devices. The list 77 of available rendering devices may have one or more rendering devices, such as, for example, one or more of the rendering devices 21,22,23. The renderer menu 75 and/or the list 77 may enable the user 12 to select a new target rendering device from the available rendering devices. The renderer menu 75 may appear, may be accessed and/or may be used in response to the user 12 invoking the renderer selection control/indication 53 and/or in response to the user 12 invoking the single control/indication element 71 using the second method for invoking the single control/indication element 71.

As generally illustrated in FIG. 6, the list 77 of available rendering devices may have representations for a gaming console, a PC, a digital photo frame and a television. The list 77 of available rendering devices may vary based on the embodiment of the media application and the available rendering devices, and the present invention is not limited to a specific embodiment of the renderer menu 75 or the list 77.

The renderer menu 75 and/or the list 77 may display representations for the available rendering devices using a text label, a graphic symbol and/or icon, a combination of a text label and a graphic symbol and/or icon, and/or the like. The arrangement of the representations of the available rendering devices may vary based on the embodiment of the media application. For example, the renderer menu 75 and/or the list 77 may arrange the representations of the available rendering devices horizontally and/or in a grid. As another example, the renderer menu 75 and/or the list 77 may be displayed as a carousel of graphic icons. The renderer menu 75 may provide additional tools and/or additional options for navigating and/or selecting among the available rendering devices. For example, if the list 77 is larger than the size of the display screen of the mobile device 11, the renderer menu 75 may provide scrolling controls to navigate through the list 77. The present invention is not limited to a specific method of displaying, navigating and/or selecting from the list 77 of available rendering devices.

The renderer menu 75 may display a subset of the available rendering devices in the home network 20. The subset may be determined based on settings and/or preferences established by the user 12 and/or the “media in context” in the media application. The subset may depend on other factors, such as, for example, the number of times the available rendering devices were previously selected and/or used, which available rendering devices were recently used for media types present in the “media in context,” which available rendering devices were recently used for media transfer, and/or the like.

In an embodiment, the subset of the available rendering devices displayed in the renderer menu 75 may be the available rendering devices which are capable of and/or suitable for rendering the “media in context” of the media application. In another embodiment, the media application may display a full set of the available rendering devices in the renderer menu 75 and/or may graphically distinguish the available rendering devices which are suitable for rendering the “media in context” from the available rendering devices which are not suitable for rendering the “media in context.” For example, the renderer menu 75 may display the full set of the available rendering devices and may “gray out” the rendering devices which are not capable of and/or not suitable for rendering the “media in context.”

In yet another embodiment, the media application may arrange the rendering devices in the renderer menu 75 in an order based on the suitability of the rendering devices for rendering the “media in context.” For example, if the “media in context” is a set of digital music files, the media application may display a dedicated audio rendering device, such as, for example, a high quality digital stereo system, at a higher position in the list 77 relative to a multipurpose rendering device, such as, for example, a digital television. Accordingly, the media application may indicate that the high quality digital stereo system may be more suitable for rendering the set of digital music files relative to the digital television.

The renderer menu 75 may display renderer settings controls 79 for one or more of the available rendering devices. The user 12 may invoke one of the renderer settings controls 79 to access and/or modify settings for the one of the available rendering devices associated with the one of the renderer settings controls 79. For example, a digital photo frame may have settings for an amount of time to display each photograph in a slideshow, for whether to stretch photos or maintain an aspect ratio of the photos, for brightness of display, and/or the like. As another example, a stereo device may have settings for a playback volume, for equalizer controls, for surround sound effects, and/or the like. As yet another example, the available rendering devices may have settings for defining, modifying and/or personalizing visual representations of the available rendering devices in the set of controls and indications 35 and/or the renderer menu 75. For example, a graphic icon and/or a text label used to represent a rendering device may be defined, modified and/or selected by the user 12. The present invention is not limited to specific settings which may be accessed and/or modified by the user 12 using the renderer settings controls 79.

The set of controls and indications 35 may indicate network errors and/or other problems which may prevent the rendering of the media content 15. The set of controls and indications 35 may enable the user 12 to correct the network errors and/or the other problems. FIGS. 7A, 7B and 7C generally illustrate an error indication 80, error information 81, and an error correction control 82 which may be used by the set of controls and indications 35 in an embodiment of the present invention. The error indication 80 may inform the user 12 of the existence of an error condition. The error information 81 may provide information so that the user 12 may understand the nature and/or the cause of the error condition. The error correction control 82 may provide a means to resolve the error condition so that a successful media transfer may be enabled.

FIG. 7A illustrates an embodiment of the set of controls and indications 35 which may indicate network errors and/or other problems and/or may enable the user 12 to correct the network errors and/or the other problems. For example, the embodiment depicted in FIG. 7A may be implemented by the embodiment of the set of controls and indications 35 generally illustrated in FIG. 3. The error indication 80 may be displayed as an “X” on the media transfer indication 52, for example. The error indication 80 may indicate visually that the transfer of the media content 15 is not currently possible due to an error condition. The error information 81 may be displayed as a text label which may replace the renderer selection control/indication 53. For example, as shown in FIG. 7A, the text label may state “Wi-Fi not available.” The error correction control 82 may be displayed as a selectable and/or invocable element which may replace the media transfer control 51. As shown in FIG. 7A, the error correction control 82 may have a text label, such as, for example, “Fix,” which may indicate that the error condition may be corrected by invoking the error correction control 82. For example, by invoking the error correction control 82, the user 12 may access options to activate the Wi-Fi connection capabilities of the mobile device and/or select an available Wi-Fi network to establish a connection, identify the available rendering devices and/or enable the transfer of the media content 15.

FIG. 7B illustrates an embodiment of the set of controls and indications 35 which may indicate network errors and/or other problems and/or may enable the user 12 to correct the network errors and/or the other problems. For example, the embodiment depicted in FIG. 7B may be implemented by the embodiment of the set of controls and indications 35 generally illustrated in FIG. 4. As another example, the embodiment depicted in FIG. 7B may be implemented by the previously discussed embodiment of the set of controls and indications 35 formed by the media transfer control 51 and the interface element which combines the media transfer indication 52 and the renderer selection control/indication 53.

As shown in FIG. 7B, the error indication 80 may be displayed as a triangle symbol containing an exclamation point, for example. The error information 81 may be displayed as a text label, such as, for example, “No Network Available.” The combination of the error indication 80 and the error information may be displayed instead of the renderer selection control/indication 53. The error correction control 82 may be displayed as a selectable and/or invocable element which may replace the media transfer control 51. The error correction control 82 may have a text label, such as, for example, “Connect,” which may indicate that the error condition may be corrected by invoking the error correction control 82. For example, by invoking the error correction control 82, the user 12 may connect the mobile device 11 to the home network 20, may identify the available rendering devices and/or may enable the transfer of the media content 15.

FIG. 7C illustrates an embodiment of the set of controls and indications 35 which may indicate network errors and/or other problems and/or may enable the user 12 to correct the network errors and/or the other problems. For example, the embodiment depicted in FIG. 7C may be implemented by the embodiment of the set of controls and indications 35 generally illustrated in FIG. 5. The error indication 80, the error information 81 and/or the error correction control 82 may be combined into a single error indication/correction element 83 which may be displayed instead of the single control/indication element 71.

As shown in FIG. 7C, the error indication 80 and the error information 81 may be combined into the single error indication/correction element 83 which may be, for example, a graphic symbol which may indicate a connection problem. Error correction control capability may be indicated with a text label which may instruct the user 12 that the connection problem may be fixed by tapping the control element. For example, the user 12 may tap the single error indication and correction element 83 using a touchscreen available on the mobile device 11. By invoking the single error indication and correction element 83, the user 12 may access options to correct the connection problem, to restore the connection, to identify the available rendering devices, and/or to enable a subsequent media transfer to a target rendering device.

In an embodiment, the media application may update the error indication 80, the error information 81 and/or the error correction control 82 to reflect the presence or the absence of network errors and/or other problems. For example, the presence or the absence of network errors and/or other problems may be indicated to the user 12 regardless of whether the user 12 has invoked any of the set of controls and indications 35 during a current rendering session.

In an embodiment, the media application may update the error indication 80, the error information 81 and/or the error correction control 82 in response to user input on the mobile device 11. For example, the user 12 may invoke the media transfer control 51 to enable the transfer of the media content to a target rendering device. As a result, the media application may direct the target rendering device to begin rendering the media content and/or may discover the network error and/or the other problem which may prevent the target rendering device from rendering the media content. If the media application discovers the network error and/or the other problem, the media application may update the set of controls and indications 35 to present the error indication 80, the error information 81 and/or the error correction control 82.

In an embodiment, the media application may indicate the network error and/or the other problem using means other than and/or in addition to the error indication 80, the error information 81 and/or the error correction control 82. For example, the media application may display an error window, a dialog box, a popup message and/or the like to inform the user 12 of the network error and/or the other problem discovered by the media application. The present invention is not limited to a specific embodiment of the means of indicating error conditions to the user 12.

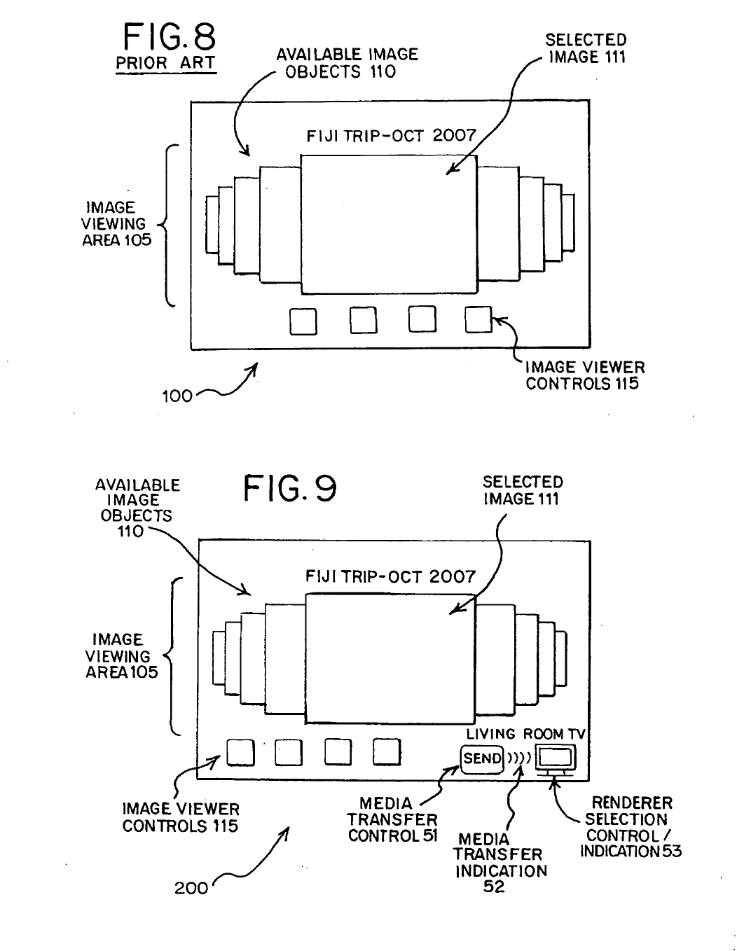

In an embodiment, the set of controls and indications 35 may be used in typical media applications on the mobile device 11. FIG. 8 generally illustrates a typical user interface 100 of an image viewer application on the mobile device 11. The image viewer application may enable the user 12 to access and/or view images, such as, for example, digital photographs which may be stored on and/or accessible to the mobile device 11. The typical user interface 100 of the image viewer application may have an image viewing area 105. The image viewer application may display one or more available image objects 110 in the image viewing area 105. The image viewer application may have a selected image 111 which may be highlighted, displayed centrally and/or displayed in another distinguishing way. The typical user interface 100 may have image viewer controls 115 which may enable the user 12 to browse, select, organize, manipulate and/or view the available image objects 110. For example, the image viewer controls 115 may navigate through the available image objects 110, search for an image in the available image objects 110, arrange a plurality of the available image objects 110 into an album and/or a slideshow, rate an image, mark an image as a favorite, sort and/or retrieve images based on ratings and/or favorites, and/or the like. The image viewer controls 115 may enable the user 12 to play an album or a slideshow in automatic fashion on the display screen of the mobile device 11. The typical user interface 100 of the image viewer application may have other controls and/or functions not presented here.

The image viewer application may lack controls and/or functions for transferring the media content 15 to the available rendering devices in the home network 20. The set of controls and indications 35 may enable the image viewer application to transfer the media content 15 to the available rendering devices in the home network 20 in an embodiment of the present invention. FIG. 9 generally illustrates a user interface 200 of the image viewer application in an embodiment of the present invention. The user interface 200 may be formed by addition of the set of controls and indications 35 to the typical user interface 100 of the viewer application. The image viewer controls 115 of the typical user interface 100 may have been minimally rearranged to create space on the user interface 200 for the set of controls and indications 35. As generally illustrated in FIG. 9, the set of controls and indications 35 of the user interface 200 of the image viewer application may be based on the embodiment of the set of controls and indications 35 depicted in FIG. 3. However, any of the forms and the illustrations of the set of controls and indications 35 presented herein may be added to the typical user interface 100 of the image viewer application to form the user interface 200, and the present invention is not limited to a specific embodiment of the set of controls and indications 35 added to the typical user interface 100 of the image viewer application to form the user interface 200.

In an embodiment, the set of controls and indications 35 may provide the media transfer control 51, the media transfer indication 52 and the renderer selection control/indication 53. In this embodiment, the user 12 of the image viewer application may access all of the controls, the functions and/or the indications of the set of controls and indications 35 described herein.

For example, the user 12 may execute the image viewer application to access and/or view digital photographs available on the mobile device 11. The user 12 may select, may organize and/or may arrange the digital photographs using the image viewer controls 115. The user 12 may manually browse and/or may view the digital photographs on the display screen of the mobile device 11. Alternatively, the user 12 may display the digital photographs using an automatic display option, such as, for example, “Play Album,” “Play Slideshow,” and/or the like. Thus, the user 12 may experience the digital photographs using the display screen of the mobile device 11.

The user 12 may view a representation of the current target rendering device displayed by the renderer selection control/indication 53 in the user interface 200. As described previously, the indicated target rendering device may be selected for display in the set of controls and indications 35 based on user settings and/or preferences, historical records of previous media transfers, identification of the available rendering devices in the home network 20, and/or the “media in context” in the image viewer application, for example. Accordingly, the renderer selection control/indication 53 may display a representation of a target rendering device despite the user 12 not selecting and/or not specifying a target rendering device in a current image viewing session. The user 12 may accept the target rendering device without further selection and/or specification of a target rendering device. Alternatively, the user 12 may invoke the renderer selection control/indication 53 to select a new target rendering device.

The user 12 may invoke the media transfer control 51 in the user interface 200 to enable the transfer of the media content 15 to the target rendering device. As a result, the “media in context” in the image viewer application may initiate transfer to and/or rendering on the target rendering device. The “media in context” may be the selected image 111, a set of selected images, a set of all available images, a set of “favorite” images, an album and/or a slideshow currently rendering on the mobile device 11, and/or the like. The “media in context” may vary between media applications. The present invention is not limited to a specific embodiment of the “media in context” or the means by which the media application may identify the “media in context.”

If the transfer of the media content 15 is enabled using the set of controls and indications 35, the user 12 may utilize the image viewer controls 115 to browse, discover, select, organize, and/or view additional images and/or additional sets of images. As a result, the additional images and/or the additional sets of images may transfer from the image viewer application to the target rendering device for rendering.

If the transfer of the media content 15 is enabled, the user 12 may invoke the renderer selection control/indication 53 to select a new target rendering device. As a result, the transfer to and/or the rendering of the media content 15 on the initial target rendering device may be stopped, and/or the transfer to and/or the rendering of the media content 15 on the new target rendering device may begin.

If the transfer of the media content 15 is enabled, the user 12 may invoke the media transfer control 51 in the user interface 200 to disable the transfer of the media content 15 to the target rendering device. As a result, the transfer of the media content 15 to the target rendering device may be stopped, and/or the target rendering device may stop rendering the media content 15 from the image viewer application.

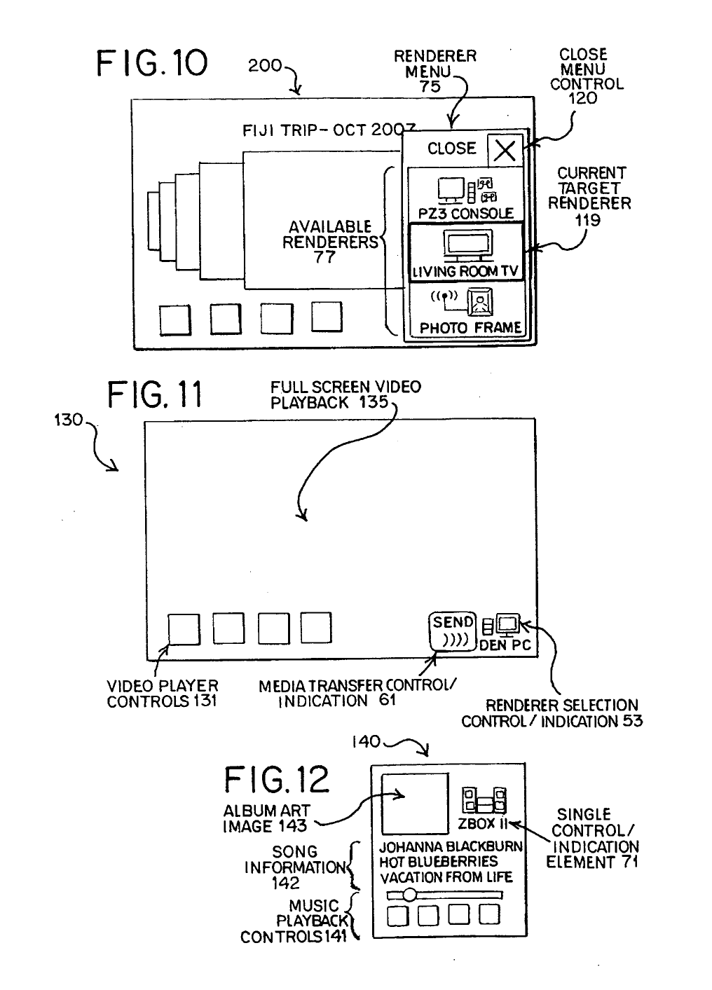

The user 12 may invoke the renderer selection control/indication 53 in the user interface 200 to select a new target rendering device. As a result, as generally illustrated in FIG. 10, the image viewer application and/or the set of controls and indications 35 may display the renderer menu 75. The renderer menu 75 may have the list 77 of available rendering devices. The renderer menu 75 may highlight, emphasize and/or otherwise indicate a representation 119 of the currently selected target rendering device. The renderer menu 75 may display a control 120 in the user interface 200 for closing the renderer menu 75 without changing the target rendering device. The user 12 may select a new target rendering device using the renderer menu 75. Alternatively, the user 12 may close the renderer menu 75 without selecting a new target rendering device.

The image viewer application may encounter an error condition which may prevent the transfer of the media content 15 to the available rendering devices in the home network 20. The user interface 200 of the image viewer application and/or the set of controls and indications 35 may indicate the error condition, may provide information about the error condition, and/or may present a means for correcting and/or resolving the error condition. Methods for indicating, informing and/or correcting the error condition may be used by the set of controls and indications 35 as previously described.

FIG. 11 generally illustrates a user interface 130 of a video player application which may have the set of controls and indications 35. As generally illustrated in FIG. 11, the set of controls and indications 35 added to the user interface 130 of the video player application may be based on the embodiment of the set of controls and indications 35 depicted in FIG. 4. However, any of the forms and the illustrations of the set of controls and indications 35 presented herein may be added to the user interface 130 of the video player application. The presented invention is not limited to a specific embodiment of the set of controls and indications 35 added to the user interface 130 of the video player application.

In an embodiment, the set of controls and indications 35 may provide the media transfer control/indication 61 and the renderer selection control/indication 53. In this embodiment, the user 12 of the video player application may access all of the controls, the functions and/or the indications of the set of controls and indications 35 described herein.

For example, the user 12 may execute the video player application to access and/or view video content which may be stored locally on the mobile device 11 and/or may be accessible to the mobile device 11 using a network connection. The user 12 may identify, browse, select, arrange, edit and/or use the video content using video player controls 131. The user 12 may control the rendering of selected video content on the display screen of the mobile device 11 using the video player controls 131. The user 12 may render the selected video content in a playback area 135 of the display screen of the mobile device 11. For example, as generally illustrated in FIG. 11, the playback area 135 may be a full screen video playback area, and/or the video player controls 131 may be displayed as overlays on the video content and/or the playback area 135. The user interface 130 of the video player application may have other forms, layouts and appearances, and the present invention is not limited to a specific embodiment of the user interface 130 of the video player application.

The user 12 may view the representation of the current target rendering device indicated by the renderer selection control/indication 53. As described previously, an initial target rendering device may be selected for display in the set of controls and indications 35 based on user settings and/or preferences, historical records of previous media transfers, identification of available rendering devices in the home network 20, and/or the “media in context” in the video player application, for example. Accordingly, the renderer selection control/indication 53 may display a representation of a target rendering device despite the user 12 not selecting and/or not specifying a target rendering device in a current video viewing session. The user 12 may accept the target rendering device without further selection and/or specification of a target rendering device. Alternatively, the user 12 may invoke the renderer selection control/indication 53 to select a new target rendering device.

The user may invoke the media transfer control/indication 61 to enable the transfer of the media content 15 to the target rendering device. As a result, the “media in context” in the video player application may begin transfer to and/or rendering on the target rendering device. For example, as generally illustrated in FIG. 11, the “media in context” may transfer to and/or may be rendered on a PC device located in the den of the home as indicated by the renderer selection control/indication 53. The “media in context” may be selected video content and/or the video content currently playing in the video player application.

If the transfer of the media content 15 is enabled using the set of controls and indications 35, the user 12 may utilize the video player controls 131 to control the rendering of the video content on the display screen of the mobile device 11 and/or to control the rendering of the video content on the target rendering device. The user 12 may identify, may browse, may select, may arrange, may edit and/or may use additional video content using the video player controls 131. As a result, the additional video content may transfer to and/or may be rendered by the target rendering device.

If the transfer of the media content 15 is enabled, the user 12 may invoke the renderer selection control/indication 53 to select a new target rendering device. As a result, the transfer to and/or the rendering of the media content 15 on the initial target rendering device may be stopped, and the transfer to and/or the rendering of the media content 15 on the new target rendering device may begin.

If the transfer of the media content 15 is enabled, the user 12 may invoke the media transfer control/indication 61 to disable the transfer of the media content 15 from the video player application to the target rendering device. As a result, the transfer of the media content 15 to the target rendering device may be stopped, and/or the target rendering device may stop rendering the media content 15 from the video player application.

FIG. 12 generally illustrates a user interface 140 of a music player application which may provide the set of controls and indications 35 using the single control/indication element 71 in an embodiment of the current invention. The music player application may utilize any of the forms and the illustrations of the set of controls and indications 35 presented herein, and the present invention is not limited to a specific embodiment of the set of controls and indications 35 added to the user interface 140 of the music player application. However, use of the single control/indication element 71 may be advantageous if the size of the display screen is limited. For example, the mobile device 11 may be a low-end mobile phone, a compact MP3 player, a wristwatch with music playback capabilities, and/or the like. The single control/indication element 71 may be used to provide the set of controls and indications 35 in a limited display space.

The user 12 may execute the music player application to access and/or view music content which may be stored locally on the mobile device 11 and/or which may be accessible to the mobile device 11 using a network connection. The user 11 may discover, may browse, may select, may arrange, may edit and/or may use the music content using the music player controls 141. For example, the user 12 may arrange the music content into playlists and/or may access existing playlists to edit, use, and/or play back the playlists. The user 12 may play selected music content and/or may control the rendering of the music content on the mobile device 11 using the music player controls 141. For example, as generally illustrated in FIG. 12, the music player application may provide song information 142 and/or an album art image 143. The user interface 140 of the music player application may have other forms, layouts and appearances, and the present invention is not limited to a specific embodiment of the user interface 140 of the music player application.

The user 12 may view the representation of the current target rendering device indicated by the single control/indication element 71. As described previously, an initial target rendering device may be selected for display in the single control/indication element 71 based on user settings and/or preferences, historical records of previous media transfers, identification of available rendering devices in the home network 20, and/or the “media in context” in the music player application, for example. Accordingly, the single control/indication element 71 may display a representation of a target rendering device despite the user 12 not selecting and/or not specifying a target rendering device in a current music listening session. The user 12 may accept the target rendering device without further selection and/or specification of a target rendering device. Alternatively, the user 12 may invoke the single control/indication element 71 using the second method for invoking the single control/indication element 71 to select a new target rendering device.

The user may invoke the single control/indication element using the first method for invoking the single control/indication element 71 to enable the transfer of the media content 15 from the music player application to the target rendering device. As a result, the “media in context” in the music player application may begin transfer to and/or rendering on the target rendering device. The “media in context” may be the music content currently selected and/or currently playing in the music player application. The “media in context” may be music content associated with a playlist selected and/or edited in the music player application. The “media in context” may be another set of media content relevant to the user 12 of the music player application. As generally illustrated in FIG. 12, the media content 15 may transfer to and/or may be rendered on a Zbox II device as indicated by the single control/indication element 71.

If the transfer of the music content to the rendering device is enabled using the single control/indication element 71, the user 12 may utilize the music player controls 141 to control the rendering of the music content on the target rendering device. The user 12 may identify, may browse, may select, may arrange, may edit and/or may use additional music content using the music player controls 141. As a result, the additional music content may be transferred to and/or may be rendered by the target rendering device.

If the transfer of the music content from the music player application to the rendering device is enabled, the user 12 may invoke the single control/indication element 71 using the second method for invoking the single control/indication element 71 to select a new target rendering device. As a result, the transfer to and/or the rendering of the music content on the initial target rendering device may be stopped, and the transfer to and/or the rendering of music content on the new target rendering device may begin.

If the transfer of the music content from the music player application to the rendering device is enabled, the user may invoke the single control/indication element 71 using the first method for invoking the single control/indication element 71 to disable the transfer of the music content to the target rendering device. As a result, the transfer of the music content to the target rendering device may be stopped, and/or the target rendering device may stop rendering the music content from the music player application. The user 12 may continue to access, use, and/or play the music content on the mobile device if the media transfer is disabled using the single control/indication element 71.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for transferring media content from a mobile device to a home network wherein the mobile device has a user interface and further wherein the home network has rendering devices, the method comprising the steps of:
displaying a media transfer control, a media transfer indication and a renderer selection control/indication concurrently in the user interface of the mobile device during execution of a media application by the mobile device;
identifying first media content using the media application;
identifying a first target rendering device of the rendering devices in the home network wherein the renderer selection control/indication identifies the first target rendering device to a user of the mobile device;
accepting user input on the user interface of the mobile device which selects the media transfer control;
rendering the first media content on the first target rendering device in response to selection of the media transfer control; and
indicating to the user of the mobile device that the first target rendering device is rendering the first media content wherein the media transfer indication indicates to the user of the mobile device that the first target rendering device is rendering the first media content.

2. The method of claim 1 further comprising the step of:
displaying playback controls, the media transfer control, the media transfer indication and the renderer selection control/indication concurrently in the user interface of the mobile device wherein the playback controls enable the user of the mobile device to control rendering of the first media content on the first target rendering device.

3. The method of claim 1 further comprising the step of:
displaying a webpage in the user interface of the mobile device wherein the first media content is identified as internet media content selected from the webpage by the user of the mobile device.

4. The method of claim 1 further comprising the step of:
obtaining the first media content from a media server located in the home network in response to the selection of the media transfer control wherein the first target rendering device obtains the first media content from the media server in response to the selection of the media transfer control without the mobile device transmitting the first media content to the first target rendering device.

5. The method of claim 1 further comprising the step of:
transmitting the first media content from local storage on the mobile device to the first target rendering device in response to the selection of the media transfer control.

6. The method of claim 1 further comprising the step of:
transmitting the first media content from a remote content provider connected to the mobile device by a network which is a different network than the home network wherein the remote content provider transmits the first media content to the mobile device using the network and the mobile device transmits the first media content to the first target rendering device using the home network in response to the selection of the media transfer control.

7. The method of claim 1 further comprising the step of:
graphically connecting the media transfer control and the renderer selection control/indication using the media transfer indication while the first target rendering device is rendering the first media content.

8. The method of claim 1 further comprising the step of:
automatically identifying the first target rendering device from the rendering devices in the home network in response to identification of the first media content wherein the mobile device identifies the first target rendering device in response to the identification of the first media content without selection of the first target rendering device by the user after the identification of the first media content and further wherein the first target rendering device has media capabilities which correspond to the first media content.

9. The method of claim 1 further comprising the steps of:
accepting a series of user input events on the mobile device over a time period wherein each of the user input events in the series cause changes to a set of media content selected in the media application; and
periodically updating a representation of a current target rendering device to reflect the changes to the set of media content selected in the media application wherein the renderer selection control/indication displays the representation of the current target rendering device and further wherein the representation of the current target rendering device identifies the first target rendering device when the first media content is selected in the media application.

10. The method of claim 1 further comprising the steps of:
identifying a second target rendering device of the rendering devices in the home network wherein the renderer selection control/indication identifies the second target rendering device to the user of the mobile device before identification of the first target rendering device wherein the first target rendering device and the second target rendering device are both capable of rendering the first media content; and
detecting unavailability of the second target rendering device wherein the mobile device detects the unavailability of the second target rendering device wherein the renderer selection control/indication identifies the first target rendering device to the user in response to detection of the unavailability of the second target rendering device.

11. The method of claim 1 wherein the media transfer control and the media transfer indication are a single functional element provided by the user interface of the mobile device and further wherein the single functional element provides the media transfer control and the media transfer indication.

12. The method of claim 1 wherein the media transfer control, the media transfer indication and the renderer selection control/indication are a single functional element provided by the user interface of the mobile device and further wherein a user of the mobile device uses a first invocation of the single functional element to select the media transfer control and uses a second invocation of the single functional element to select the renderer selection control/indication wherein the user interface displays a list of available rendering devices in the home network in response to selection of the renderer selection control/indication and further wherein the first invocation and the second invocation select the single functional element in different ways.

13. The method of claim 1 further comprising the step of:
replacing the media transfer indication with an error indication in response to an error preventing the first target rendering device from rendering the first media content after selection of the media transfer control wherein the error indication indicates that the first target rendering device cannot render the first media content.

14. The method of claim 1 further comprising the step of:
replacing the renderer selection control/indication with error information in response to an error preventing the first target rendering device from rendering the first media content after selection of the media transfer control wherein the error information describes the error.

15. The method of claim 1 further comprising the step of:
replacing the media transfer control with an error correction control wherein selection of the error correction control by user input in the user interface of the mobile device enables correction of an error preventing the first target rendering device from rendering the first media content.

16. The method of claim 1 further comprising the step of:
selecting the media transfer control on the mobile device after initiating rendering of the first media content on the first target rendering device wherein selecting the media transfer control after initiating rendering of the first media content on the first target rendering device discontinues rendering of the first media content on the first target rendering device.

17. A method for transferring media content from a mobile device to a home network wherein the mobile device has a user interface and further wherein the home network has rendering devices, the method comprising the steps of:
displaying a media transfer control and a renderer selection control/indication concurrently in the user interface of the mobile device during execution of a media application by the mobile device wherein the renderer selection control/indication visually indicates a first target rendering device;
identifying the media content using the media application;
accepting first user input in the user interface of the mobile device wherein the first user input selects the renderer selection control/indication;
displaying a list of available rendering devices in the home network wherein the user interface of the mobile device displays the list in response to selection of the renderer selection control/indication;
accepting second user input in the user interface of the mobile device wherein the second user input selects a second target rendering device from the list of available rendering devices; and
rendering the media content on the second target rendering device.

18. The method of claim 17 further comprising the step of:
indicating the rendering devices in the home network which have media capabilities which correspond to the media content wherein the list of available rendering devices indicates the rendering devices in the home network which have the media capabilities which correspond to the media content.

19. The method of claim 17 further comprising the step of:
indicating the rendering devices in the home network which have media capabilities which do not correspond to the media content wherein the list of available rendering devices indicates the rendering devices in the home network which do not have the media capabilities which correspond to the media content.

20. The method of claim 17 further comprising the step of:
automatically identifying the first target rendering device from the rendering devices in the home network before the renderer selection control/indication visually indicates the first target rendering device wherein the mobile device identifies the first target rendering device without selection of the first target rendering device by the user.

21. The method of claim 17 wherein the media transfer control and the renderer selection control/indication are a single functional element provided by the user interface of the mobile device and further wherein the single functional element provides the media transfer control and the renderer selection control/indication.

22. The method of claim 17 further comprising the step of:
providing renderer setting controls with the list of available rendering devices wherein the user interface of the mobile device displays the renderer setting controls in response to selection of the renderer selection control/indication and further wherein the renderer setting controls enable a user of the mobile device to establish settings associated with each of the available rendering devices wherein a user of the mobile device establishes the settings for the second target rendering device before the second user input and further wherein the second target rendering device implements the settings during rendering of the media content.

23. The method of claim 17 further comprising the step of:
changing the renderer selection control/indication from a first icon to a second icon in response to selection of the second rendering device wherein the second icon visually indicates the second target rendering device.

24. The method of claim 17 further comprising the step of:
accepting third user input in the user interface of the mobile device wherein the third user input selects the media transfer control and further wherein the rendering of the media content on the second target rendering device is initiated in response to selection of the media transfer control.

25. A system for transferring media content to rendering devices in a home network using a mobile device, the system comprising:
a media application executing on the mobile device wherein the media application enables a user to identify selected media content;
a media transfer control which enables the user to identify a selected mode of operation from a first mode of operation and a second mode of operation wherein the first mode of operation transfers the selected media content to one or more of the rendering devices in the home network and further wherein the second mode of operation does not transfer the selected media content to any of the rendering devices in the home network;
a media transfer indication which visually indicates the selected mode of operation; and
a renderer selection control/indication which visually indicates a target rendering device from the rendering devices in the home network and which enables the user to change the target rendering device wherein the first mode of operation transfers the selected media content to the target rendering device.

26. The system of claim 25 further comprising:
a user interface of the mobile device wherein the media transfer control, the media transfer indication, and the renderer selection control/indication are concurrently displayed in the user interface during execution of the media application.

27. The system of claim 25 further comprising:
a plurality of media applications executable on the mobile device wherein each of the plurality of media applications enables the user to identify the selected media content and further wherein each of the plurality of media applications provides the media transfer control, the media transfer indication and the renderer selection control/indication.

28. The system of claim 25 wherein the media transfer control and the media transfer indication are a single functional element provided by the mobile device and further wherein the single functional element provides the media transfer control and the media transfer indication.

29. The system of claim 25 wherein the media transfer indication and the renderer selection control/indication are a single functional element provided by the mobile device and further wherein the single functional element provides the media transfer indication and the renderer selection control/indication.

30. The system of claim 25 wherein the media transfer control, the media transfer indication and the renderer selection control/indication are a single functional element provided by the mobile device and further wherein the single functional element provides the media transfer control, the media transfer indication and the renderer selection control/indication.

31. The system of claim 25 wherein the mobile device automatically identifies the target rendering device from the rendering devices in the home network in response to identification of the selected media content by the user and further wherein the mobile device identifies the target rendering device without selection of the target rendering device by the user after the identification of the selected media content wherein the target rendering device has media capabilities which correspond to the selected media content.

32. The system of claim 25 wherein a first rendering device and a second rendering device of the rendering devices in the home network are capable of rendering the selected media content and further wherein the renderer selection control/indication identifies the first rendering device as the target rendering device to the user of the mobile device wherein the mobile device detects unavailability of the first rendering device after identifying the first rendering device as the target rendering device and further wherein the renderer selection control/indication identifies the second rendering device as the target rendering device to the user in response to detection of the unavailability of the first target rendering device.

33. The system of claim 25 further comprising:
a list of the rendering devices in the home network wherein the list is displayed in response to user input which selects the renderer selection/control indication and further wherein the user changes the target rendering device using the list.

34. The system of claim 25 further comprising:
an error indication visually indicated by one of the media transfer indication and the renderer selection control/indication wherein the media transfer control provides at least one option to correct an error indicated by the error indication.
